(19) United States
(12) Patent Application Publication
(10) Pub. No.: US 2026/0108965 A1
(43) Pub. Date: Apr. 23, 2026

(54) HOT-BAR SOLDERING METHOD AND HOT-BAR SOLDERING SYSTEM

(71) Applicants: AMP Amermex, S.A. de C.V., Juarez (MX); TE Connectivity Solutions GmbH, Schaffhausen (CH); Tyco Electronics (Shanghai) Co., Ltd., Shanghai (CN)

(72) Inventors: Lei (Alex) Zhou, Shanghai (CN); Dandan (Emily) Zhang, Shanghai (CN); Roberto Francisco-Yi Lu, Bellevue, WA (US); Raul Guerrero, Hermosillo (MX); Xianghao (Jorge) Bao, Shanghai (CN); Yang Li, Shanghai (CN); Jorge Enrique Clayton, Hermosillo (MX)

(73) Assignees: AMP Amermex, S.A. de C.V., Juarez (MX); TE Connectivity Solutions GmbH, Schaffhausen (CH); Tyco Electronics (Shanghai) Co., Ltd., Shanghai (CN)

(21) Appl. No.: 19/364,348

(22) Filed: Oct. 21, 2025

(30) Foreign Application Priority Data
Oct. 22, 2024 (CN) 202411480706.2

(51) Int. Cl. B23K 1/19; B23K 1/00; B23K 3/08; B23K 101/42

(52) U.S. Cl. CPC B23K 1/19; B23K 1/0008; B23K 3/087; B23K 2101/42

(57) ABSTRACT

A hot-bar soldering system includes a solder bar, a distance detecting device, a fitted line generator, a distance calculating device, and a solder bar moving device. The solder bar simultaneously presses and solder soldered ends of a plurality of wires onto a plurality of pads of a circuit board respectively. The distance detecting device detects a distance between each pad and a predetermined horizontal plane. The fitted line generator generates a fitted line based on the detected distance of each pad and a position of each pad in a horizontal direction. The distance calculating device calculates an actual movement distance of the solder bar based on the generated fitted line and a preset movement distance of the solder bar in a height direction. The solder bar moving device drives the solder bar to move toward the circuit board by the actual movement distance d4 in the height direction.

### CROSS-REFERENCE TO RELATED APPLICATION

This application claims the benefit of Chinese Patent Application No. 202411480706.2 filed on Oct. 22, 2024 in the State Intellectual Property Office of China, the whole disclosure of which is incorporated herein by reference.

### FIELD OF THE DISCLOSURE

The disclosure relates to a hot-bar soldering method and a hot-bar soldering system.

### BACKGROUND OF THE INVENTION

In the prior art, when a plurality of wires are simultaneously soldered to a plurality of pads on a circuit board by using a solder bar, a movement distance of the solder bar from an initial position thereof toward the circuit board is typically constant and is calculated in advance based on a preset size and a preset shape of the circuit board. However, due to manufacturing errors, this may cause errors in the actual size and the actual shape of the circuit board, for example, the circuit board has a thickness dimension less than the preset size thereof, a surface of the circuit board is cambered, or the thickness of the circuit board is non-uniform. If the solder bar is moved at the constant preset movement distance, some wires may be not reliably pressed against the pads, which will result in pseudo soldering, thus reducing the quality of a product.

### SUMMARY OF THE INVENTION

According to an embodiment of the present disclosure, a hot-bar soldering system includes a solder bar, a distance detecting device, a fitted line generator, a distance calculating device, and a solder bar moving device. The solder bar simultaneously presses and solder soldered ends of a plurality of wires onto a plurality of pads of a circuit board respectively. The distance detecting device detects a distance between each pad and a predetermined horizontal plane. The fitted line generator generates a fitted line based on the detected distance of each pad and a position of each pad in a horizontal direction. The distance calculating device calculates an actual movement distance of the solder bar based on the generated fitted line and a preset movement distance of the solder bar in a height direction. The solder bar moving device drives the solder bar to move toward the circuit board by the actual movement distance d4 in the height direction.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative view of a circuit board according to an exemplary embodiment of the present invention;

FIG. 2 shows an illustrative view of detecting a distance between each pad on a circuit board and a predetermined horizontal plane by using a sensor;

FIG. 3 shows an exemplary view of a fitted line which is generated based on the detected distance between each pad on a circuit board and a predetermined horizontal plane and a horizontal position of each pad;

FIG. 4 shows an exemplary view of another fitted line which is generated based on the detected distance between each pad on a circuit board and a predetermined horizontal plane and a horizontal position of each pad;

FIG. 5 shows an exemplary view of another fitted line which is generated based on the detected distance between each pad on a circuit board and a predetermined horizontal plane and a horizontal position of each pad;

FIG. 6 shows an exemplary view of another fitted line which is generated based on the detected distance between each pad on a circuit board and a predetermined horizontal plane and a horizontal position of each pad;

FIG. 7 shows an illustrative view of positioning soldered ends of a plurality of wires to a plurality of pads of a circuit board respectively;

FIG. 8 shows an illustrative view of moving a solder bar toward a circuit board;

FIG. 9 shows an illustrative view of pressing and soldering a plurality of wires onto a plurality of pads of a circuit board by using a solder bar; and

FIG. 10 shows an illustrative perspective view of a circuit board, wires and a solder bar according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a hot-bar soldering system comprises: a solder bar configured to simultaneously press and solder soldered ends of a plurality of wires onto a plurality of pads of a circuit board respectively; a distance detecting device configured to detect a distance between each pad on the circuit board and a predetermined horizontal plane; a fitted line generator configured to generate a fitted line based on the distance of each pad detected by the distance detecting device and a position of each pad in a horizontal direction; a distance calculating device configured to calculate an actual movement distance d4 of the solder bar based on the generated fitted line and a preset movement distance d3 of the solder bar in a height direction; and a solder bar moving device configured to drive the solder bar to move toward the circuit board by the actual movement distance d4 in the height direction.

According to another embodiment of the present disclosure, a hot-bar soldering method comprises the steps of: providing a circuit board and positioning the circuit board on a horizontal reference plane; detecting a distance between each pad of a plurality of pads on the circuit board and a predetermined horizontal plane, the predetermined horizontal plane being located above the circuit board and being at a first distance d1 from the horizontal reference plane; generating a fitted line based on the detected distance between each pad and the predetermined horizontal plane and a position of each pad in a horizontal direction; providing a plurality of wires and positioning soldered ends of the plurality of wires on the plurality of pads of the circuit board respectively; providing a solder bar and positioning the solder bar at a predetermined height position above the circuit board, the predetermined height position being at a second distance d2 from the horizontal reference plane; calculating an actual movement distance d4 of the solder bar based on the generated fitted line and a preset movement distance d3 of the solder bar in a height direction; and driving the solder bar to move toward the circuit board by the actual movement distance d4 in the height direction, such that the soldered end of each wire is reliably pressed against and soldered onto the corresponding pad by the solder bar.

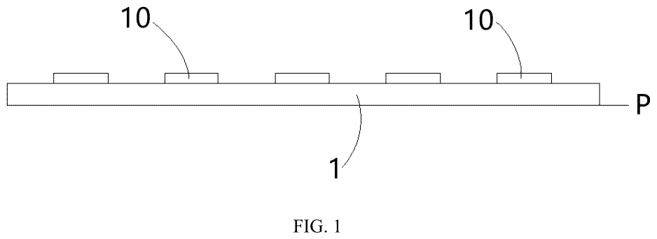

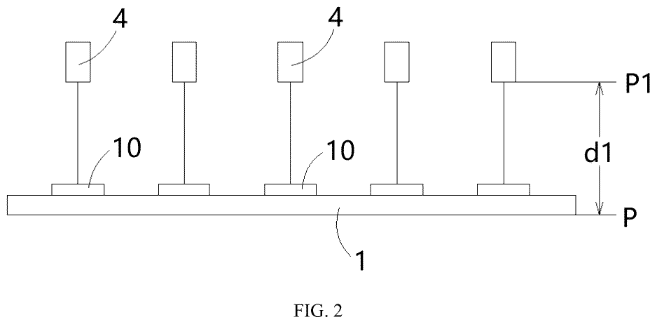

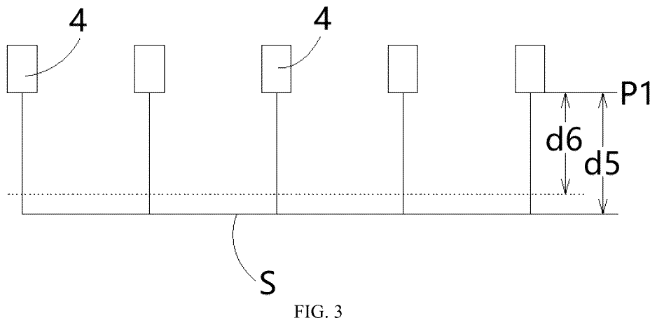

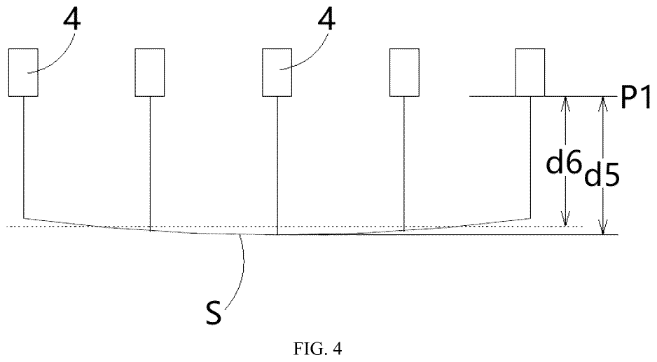

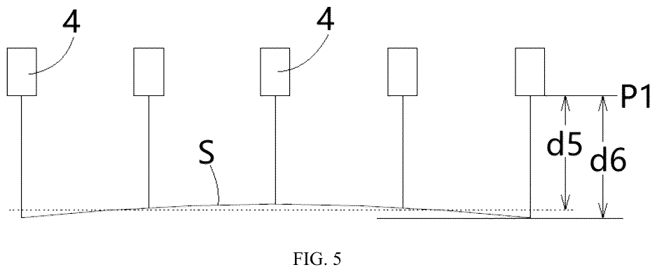

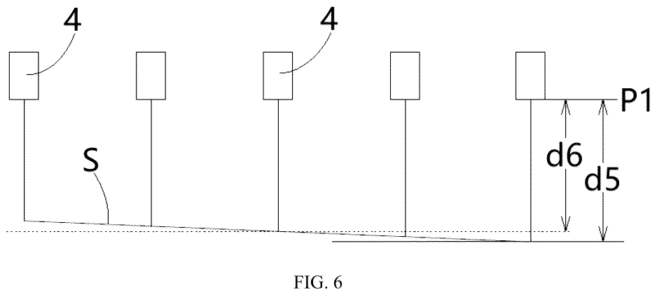

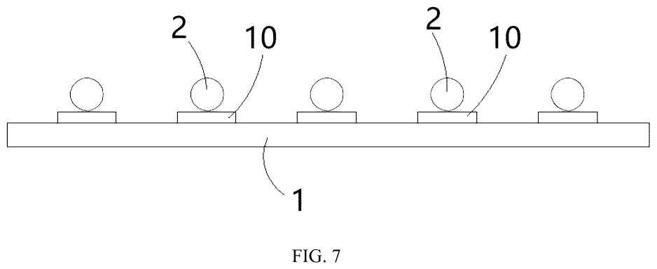

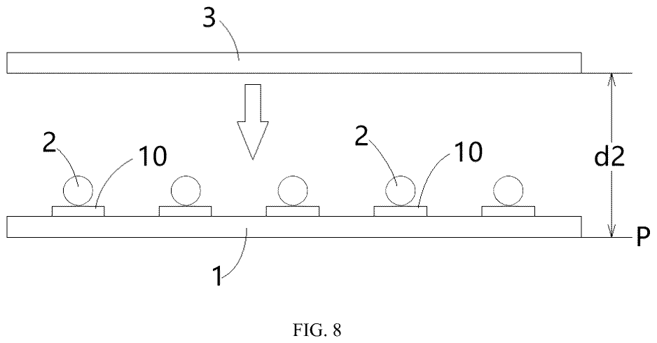

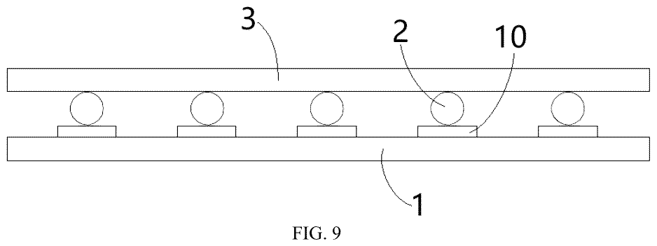

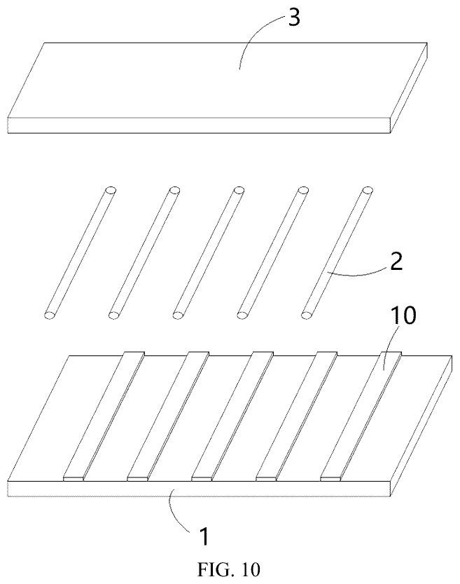

FIG. 1 shows an illustrative view of a circuit board 1 according to an exemplary embodiment of the present invention. FIG. 2 shows an illustrative view of detecting a distance between each pad 10 on a circuit board 1 and a predetermined horizontal plane P by using a sensor 4. FIG. 3 shows an exemplary view of a fitted line S which is generated based on the detected distance between each pad 10 on a circuit board 1 and a predetermined horizontal plane P and a horizontal position of each pad 10. FIG. 4 shows an exemplary view of another fitted line S which is generated based on the detected distance between each pad 10 on a circuit board 1 and a predetermined horizontal plane P and a horizontal position of each pad 10. FIG. 5 shows an exemplary view of another fitted line S which is generated based on the detected distance between each pad 10 on a circuit board 1 and a predetermined horizontal plane P and a horizontal position of each pad 10. FIG. 6 shows an exemplary view of another fitted line S which is generated based on the detected distance between each pad 10 on a circuit board 1 and a predetermined horizontal plane P and a horizontal position of each pad 10. FIG. 7 shows an illustrative view of positioning soldered ends of a plurality of wires 2 to a plurality of pads 10 of a circuit board 1 respectively. FIG. 8 shows an illustrative view of moving a solder bar 3 toward a circuit board 1. FIG. 9 shows an illustrative view of pressing and soldering a plurality of wires 2 onto a plurality of pads 10 of a circuit board 1 by using a solder bar 3. Finally, FIG. 10 shows an illustrative perspective view of a circuit board 1, wires 2 and a solder bar 3 according to an exemplary embodiment of the present invention.

As shown in FIGS. 1-10, in an exemplary embodiment of the present invention, a hot-bar soldering method is disclosed. The hot-bar soldering method comprises the following steps:

S10: as shown in FIG. 1, providing a circuit board 1 and positioning the circuit board 1 on a horizontal reference plane P;

S20: as shown in FIG. 2, detecting a distance between each pad 10 of a plurality of pads 10 on the circuit board 1 and a predetermined horizontal plane P1, the predetermined horizontal plane P1 being located above the circuit board 1 and being at a first distance d1 from the horizontal reference plane P;

S30: as shown in FIGS. 3-6, generating a fitted line S based on the detected distance between each pad 10 and the predetermined horizontal plane P1 and a position of each pad 10 in a horizontal direction;

S40: as shown in FIG. 7, providing a plurality of wires 2 and positioning soldered ends of the plurality of wires 2 on the plurality of pads 10 of the circuit board 1 respectively;

S50: as shown in FIG. 8, providing a solder bar 3 and positioning the solder bar 3 at a predetermined height position above the circuit board 1, the predetermined height position being at a second distance d2 from the horizontal reference plane P;

S60: as shown in FIG. 8, calculating an actual movement distance d4 of the solder bar 3 based on the generated fitted line S and a preset movement distance d3 of the solder bar 3 in a height direction; and

S70: as shown in FIG. 9, driving the solder bar 3 to move toward the circuit board 1 by the actual movement distance d4 in the height direction, such that the soldered end of each wire 2 is reliably pressed against and soldered onto the corresponding pad 10 by the solder bar 3.

In the embodiment shown in FIG. 3, the thickness of circuit board 1 is less than the preset thickness thereof, but the surface of the circuit board 1 remains horizontal. Therefore, the fitted line S is a horizontal straight line parallel to the predetermined horizontal plane P1. In this case, there is a difference Δd of a maximum distance d5 between the fitted line S and the predetermined horizontal plane P1 and a preset distance d6 between the pads 10 of the circuit board 1 and the predetermined horizontal plane P1. Theoretically, if the circuit board 1 has no errors, the maximum distance d5 between the fitted line S and the predetermined horizontal plane P1 should equal the preset distance d6 between the pads 10 of the circuit board 1 and the predetermined horizontal plane P1. In other words, theoretically, the fitted line S should coincide with the horizontal straight line indicated by the dashed line in the figure.

In the embodiment shown in FIG. 4, the surface of the circuit board 1 is not a horizontal surface but a concave surface. Therefore, the fitted line S is a concave curve. In this case, there is a difference Δd of a maximum distance d5 between the fitted line S and the predetermined horizontal plane P1 and a preset distance d6 between the pads 10 of the circuit board 1 and the predetermined horizontal plane P1.

In the embodiment shown in FIG. 5, the surface of the circuit board 1 is not a horizontal surface but a convex surface. Therefore, the fitted line S is a convex curve. In this case, there is a difference Δd of a maximum distance d5 between the fitted line S and the predetermined horizontal plane P1 and a preset distance d6 between the pads 10 of the circuit board 1 and the predetermined horizontal plane P1.

In the embodiment shown in FIG. 6, the surface of the circuit board 1 is not a horizontal surface but an angled surface. Therefore, the fitted line S is an angled line. In this case, there is a difference Δd of a maximum distance d5 between the fitted line S and the predetermined horizontal plane P1 and a preset distance d6 between the pads 10 of the circuit board 1 and the predetermined horizontal plane P1.

As shown in FIGS. 1-6, in the illustrated embodiments, the horizontal axis of the coordinate system in which the fitted line S is located represents the horizontal position of each pad 10, and the vertical axis of the coordinate system represents the detected distance between each pad 10 and the predetermined horizontal plane P1. In this way, the fitted line S can be generated based on the horizontal position of each pad 10 and the distance between each pad 10 and the predetermined horizontal plane P1.

As shown in FIGS. 1-10, in the illustrated embodiments, the actual movement distance d4 of the solder bar 3 may be calculated according to the following formula:

$$d 4 = d 3 + Δ d ;$$

wherein Δd represents a difference Δd of a maximum distance d5 between the fitted line S and the predetermined horizontal plane P1 and a preset distance d6 between the pads 10 of the circuit board 1 and the predetermined horizontal plane P1.

Still referring to FIGS. 1-10, in the illustrated embodiments, the step S20 comprises: providing a plurality of sensors 4 corresponding to the plurality of pads 10 on the circuit board 1 respectively, and simultaneously detecting distances between the plurality of pads 10 on the circuit board 1 and the predetermined horizontal plane P1 by using the plurality of sensors 4. This may improve detecting efficiency, but may increase costs.

However, the present invention is not limited to the illustrated embodiments. For example, in another exemplary embodiment of the present invention, the step S20 may comprise: providing a single sensor 4 and detecting the distances between the plurality of pads 10 on the circuit board 1 and the predetermined horizontal plane P1 one by one by using the single sensor 4. This may may reduce costs, but may lower detecting efficiency.

In the illustrated embodiments, advantageously, the sensor 4 is a laser distance sensor. Moreover, the solder bar 3 is elastically deformable when being pressed. This ensures that the soldered ends of the plurality of wires 2 positioned at different heights are reliably pressed against the plurality of pads 10 on the circuit board 1 simultaneously.

As shown in FIGS. 1-10, in another exemplary embodiment of the present disclosure, a hot-bar soldering system is also disclosed. The hot-bar soldering system comprises: a solder bar 3, a distance detecting device, a fitted line generator (not shown), a distance calculating device (not shown) and a solder bar moving device (not shown). The solder bar 3 is configured to simultaneously press and solder soldered ends of the plurality of wires 2 onto the plurality of pads 10 of the circuit board 1 respectively. The distance detecting device is configured to detect the distance between each pad 10 on the circuit board 1 and the predetermined horizontal plane P1. The fitted line generator is configured to generate a fitted line S based on the distance of each pad 10 detected by the distance detecting device and the position of each pad 10 in the horizontal direction. The distance calculating device is configured to calculate the actual movement distance d4 of the solder bar 3 based on the generated fitted line S and the preset movement distance d3 of the solder bar 3 in the height direction. The solder bar moving device is configured to drive the solder bar 3 to move toward the circuit board 1 by the actual movement distance d4 in the height direction.

In the aforementioned embodiment, the fitted line generator or the distance calculating device may be a functional device of a combination of hardware and software, such as an industrial control computer running fitted software or calculation software.

In the illustrated embodiments, the actual movement distance d4 is calculated according to the following formula:

$$d 4 = d 3 + Δ d ;$$

wherein Δd represents a difference Δd of a maximum distance d5 between the fitted line S and the predetermined horizontal plane P1 and a preset distance d6 between the pads 10 of the circuit board 1 and the predetermined horizontal plane P1.

The distance detecting device comprises a plurality of sensors 4, the plurality of sensors 4 correspond to the plurality of pads 10 on the circuit board 1 respectively, and is configured to simultaneously detect the distances between the plurality of pads 10 on the circuit board 1 and the predetermined horizontal plane P1. The distance detecting device comprises a single sensor 4, and the hot-bar soldering system further comprises a sensor moving device configured to move the single sensor 4 in the horizontal direction, to detect the distances between the plurality of pads 10 on the circuit board 1 and the predetermined horizontal plane P1 one by one by using the single sensor 4.

In the illustrated embodiments, the sensor 4 is a laser distance sensor. The solder bar 3 is elastically deformable when being pressed, to ensure that the soldered ends of the plurality of wires 2 positioned at different heights are reliably pressed against the plurality of pads 10 on the circuit board 1 simultaneously.

The hot-bar soldering system further comprises a circuit board fixing clamp and a wire fixing clamp. The circuit board fixing clamp is configured to fix and position the circuit board 1. The wire fixing clamp is configured to fix and position the plurality of wires 2, such that the soldered ends of the plurality of wires 2 are positioned on the plurality of pads 10 of the circuit board 1 respectively.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A hot-bar soldering method, comprising the following steps:
providing a circuit board and positioning the circuit board on a horizontal reference plane;
detecting a distance between each pad of a plurality of pads on the circuit board and a predetermined horizontal plane, the predetermined horizontal plane being located above the circuit board and being at a first distance d1 from the horizontal reference plane;
generating a fitted line based on the detected distance between each pad and the predetermined horizontal plane and a position of each pad in a horizontal direction;
providing a plurality of wires and positioning soldered ends of the plurality of wires on the plurality of pads of the circuit board respectively;
providing a solder bar and positioning the solder bar at a predetermined height position above the circuit board, the predetermined height position being at a second distance d2 from the horizontal reference plane;
calculating an actual movement distance d4 of the solder bar based on the generated fitted line and a preset movement distance d3 of the solder bar in a height direction; and
driving the solder bar to move toward the circuit board by the actual movement distance d4 in the height direction, such that the soldered end of each wire is pressed against and soldered onto the corresponding pad by the solder bar.

2. The hot-bar soldering method according to claim 1, wherein the actual movement distance d4 is calculated according to the following formula:
$$d 4 = d 3 + Δ d ;$$
wherein Δd represents a difference Δd of a maximum distance d5 between the fitted line and the predetermined horizontal plane and a preset distance d6 between the pads of the circuit board and the predetermined horizontal plane.

3. The hot-bar soldering method according to claim 1, wherein the step of detecting the distance between each pad of the plurality of pads comprises providing a plurality of sensors corresponding to the plurality of pads on the circuit board respectively.

4. The hot-bar soldering method according to claim 3, wherein the step of detecting the distance between each pad of the plurality of pads further comprises simultaneously detecting distances between the plurality of pads on the circuit board and the predetermined horizontal plane by using the plurality of sensors.

5. The hot-bar soldering method according to claim 4, wherein the plurality of sensors are laser distance sensors.

6. The hot-bar soldering method according to claim 1, wherein the step of detecting the distance between each pad of the plurality of pads comprises providing a single sensor.

7. The hot-bar soldering method according to claim 6, wherein the step of detecting the distance between each pad of the plurality of pads further comprises detecting the distances between the plurality of pads on the circuit board and the predetermined horizontal plane one by one with the single sensor.

8. The hot-bar soldering method according to claim 1, wherein the solder bar is elastically deformable when being pressed and adapted to ensure that the soldered ends of the plurality of wires positioned at different heights are pressed against the plurality of pads on the circuit board simultaneously.

9. A hot-bar soldering system, comprising:
a solder bar adapted to simultaneously press and solder soldered ends of a plurality of wires onto a plurality of pads of a circuit board respectively;
a distance detecting device adapted to detect a distance between each pad on the circuit board and a predetermined horizontal plane;
a fitted line generator adapted to generate a fitted line based on the distance of each pad detected by the distance detecting device and a position of each pad in a horizontal direction;
a distance calculating device adapted to calculate an actual movement distance d4 of the solder bar based on the generated fitted line and a preset movement distance d3 of the solder bar in a height direction; and
a solder bar moving device adapted to drive the solder bar to move toward the circuit board by the actual movement distance d4 in the height direction.

10. The hot-bar soldering system according to claim 9, wherein the actual movement distance d4 is calculated according to the following formula:
$$d 4 = d 3 + Δ d ;$$
wherein Δd represents a difference Δd of a maximum distance d5 between the fitted line and the predetermined horizontal plane and a preset distance d6 between the pads of the circuit board and the predetermined horizontal plane.

11. The hot-bar soldering system according to claim 9, wherein the distance detecting device comprises a plurality of sensors, the plurality of sensors corresponding to the plurality of pads on the circuit board respectively and adapted to simultaneously detect the distances between the plurality of pads on the circuit board and the predetermined horizontal plane.

12. The hot-bar soldering system according to claim 11, wherein the sensors are laser distance sensors.

13. The hot-bar soldering system according to claim 9, wherein the distance detecting device comprises a single sensor, and the hot-bar soldering system further comprises a sensor moving device adapted to move the single sensor in the horizontal direction and detecting the distances between the plurality of pads on the circuit board and the predetermined horizontal plane one by one by using the single sensor.

14. The hot-bar soldering system according to claim 9, wherein the solder bar is elastically deformable when being pressed such that the soldered ends of the plurality of wires positioned at different heights are reliably pressed against the plurality of pads on the circuit board simultaneously.

15. The hot-bar soldering system according to claim 9, further comprising a circuit board fixing clamp adapted to fix and position the circuit board.

16. The hot-bar soldering system according to claim 15, further comprising a wire fixing clamp adapted to fix and position the plurality of wires, such that the soldered ends of the plurality of wires are positioned on the plurality of pads of the circuit board respectively.

17. A hot-bar soldering method, comprising the following steps:
S10: providing a circuit board and positioning the circuit board on a reference plane;
S20: detecting a distance between each pad of a plurality of pads on the circuit board and a predetermined plane, the predetermined plane being located above the circuit board and being at a first distance d1 from the reference plane;
S30: generating a fitted line based on the detected distance between each pad and the predetermined plane and a position of each pad in a first direction;
S40: providing a plurality of wires and positioning soldered ends of the plurality of wires on the plurality of pads of the circuit board respectively;
S50: providing a solder bar and positioning the solder bar at a predetermined height position above the circuit board, the predetermined height position being at a second distance d2 from the reference plane; and
S60: calculating an actual movement distance d4 of the solder bar based on the generated fitted line and a preset movement distance d3 of the solder bar in a height direction.

18. The hot-bar soldering method according to claim 17, further comprising the step of:
S70: driving the solder bar to move toward the circuit board by the actual movement distance d4 in the height direction, such that the soldered end of each wire is pressed against and soldered onto the corresponding pad by the solder bar.

19. The hot-bar soldering method according to claim 17, wherein the step of detecting the distance between each pad of the plurality of pads includes providing a plurality of sensors corresponding to the plurality of pads on the circuit board respectively.

20. The hot-bar soldering method according to claim 19, wherein the step of detecting the distance between each pad of the plurality of pads further includes simultaneously detecting distances between the plurality of pads on the circuit board and the predetermined plane by using the plurality of sensors.
